(19) United States
(12) Patent Application Publication
(10) Pub. No.: US 2016/0251106 A1
(43) Pub. Date: Sep. 1, 2016

(54) LIQUID HYDROCARBON CONTAINMENT SYSTEM

(71) Applicant: Albarrie Geocomposites Limited, Barrie (CA)

(72) Inventor: Peter Kuziw, Barrie (CA)

(21) Appl. No.: 14/706,320

(22) Filed: May 7, 2015

Related U.S. Application Data
(60) Provisional application No. 62/121,572, filed on Feb. 27, 2015.

(51) Int. Cl. B65D 1/34; C08K 3/36; B32B 5/06; B65D 90/04; B32B 27/30; B32B 27/32; B32B 27/12; B32B 27/08; C08F 299/02; B32B 7/08

(52) U.S. Cl. CPC B65D 1/34; C08F 299/022; C08K 3/36; B32B 5/06; B32B 7/08; B32B 27/302; B32B 27/32; B32B 27/12; B32B 27/08; B65D 90/041; B32B 2307/7265

(57) ABSTRACT

A textile barrier for containment of liquid hydrocarbons comprises a layer of viscosity modifier, wherein the viscosity modifier disperses into and raises the viscosity of the liquid hydrocarbon. A layer of absorbent may be positioned to contact the liquid hydrocarbon before the viscosity layer. The textile barrier does not significantly obstruct flow of water.

### FIELD OF THE INVENTION

The invention relates to the containment of hydrocarbons and in particular to barriers used for the containment of liquid hydrocarbons.

### BACKGROUND

Liquid hydrocarbons may comprise complex mixtures of pollutants and relatively small quantities may exert toxic effects on the environment. Spills of liquid hydrocarbons (e.g. oils, gasoline, diesel fuel and other petroleum products) from above ground storage tanks and pipelines are a growing environmental problem. For environmental reasons, it is desirable to contain such spills using containment systems thereby preventing oil from seeping into the soil and contaminating the water supply.

Environmental regulations may require above ground tanks storing liquid hydrocarbons to have a containment system for capturing liquid hydrocarbon that may leak. For instance, US Environmental Protection Agency (EPA) regulations require that above-ground liquid hydrocarbon storage tanks for containing potentially hazardous liquids be surrounded by a containment system capable of storing liquid contained in the storage tank.

Some existing containment systems rely primarily on construction of a containment dike or basin that underlies or surrounds a source of liquid hydrocarbon. The containment dike or basin may be reinforced with concrete. If and when liquid hydrocarbon leaks from the source, leakage into the environment may be prevented or reduced. However, it may also be impermeable to water from rainfall or snowfall, so periodic draining may be required.

A textile barrier may be used as part of a containment system to contain leaking or spilled liquid hydrocarbon. The textile barrier may be placed in the dike or basin. The textile barrier may comprise a layer of durable material such as a geotextile which may be resistant to biological degradation and chemicals naturally found in the environment, such as acids and alkalis.

One such textile barrier may contain several different layers. In Canadian Patent 2,560,602, a layer of swellable organic chemical is embedded between two textile layers to help reduce liquid hydrocarbon leakage. The chemical layer may be sandwiched between a substrate textile layer and a cover textile layer. The three layers may then be assembled by, for instance, needle-punching or heat-bonding to form a single textile barrier. Such textile barriers may be permeable to water, allowing water from rainfall or snowfall to drain until contacted with liquid hydrocarbon.

It is desirable to have a barrier or set of barriers that are alternatives to those already available. It is also desirable to have a barrier or set of barriers that are permeable to water (at least until contacted with liquid hydrocarbon).

Further, it may be desirable to have a barrier or set of barriers that may rapidly immobilize leaking liquid hydrocarbon. Upon contact with a textile barrier, it may take some time (e.g. more than one minute and up to several minutes) before the liquid hydrocarbon is immobilized, or stopped, from leaking through the textile barrier. In the meantime, it is possible that liquid hydrocarbon leaks into the soil, which is not desirable environmentally. A barrier or set of barriers that rapidly immobilizes liquid hydrocarbon may reduce such leaks.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

An aspect of the present invention relates to a barrier for containing a leak of a liquid hydrocarbon comprising a viscosity modifier, wherein upon contact with the liquid hydrocarbon the viscosity modifier disperses into and increases the viscosity of the liquid hydrocarbon.

A further aspect relates to the barrier above, wherein the viscosity modifier dissolves into and increases the viscosity of the liquid hydrocarbon.

A further aspect relates to the barrier above, wherein the viscosity modifier is a powder or a granulate.

A further aspect relates to the barrier above, wherein the viscosity modifier is water-insoluble.

A further aspect relates to the barrier above, wherein the viscosity modifier is highly soluble in the liquid hydrocarbon.

A further aspect relates to the barrier above, wherein the viscosity modifier is a polymer.

A further aspect relates to the barrier above, wherein the polymer comprises ethylene and/or propylene monomers.

A further aspect relates to the barrier above, wherein the polymer is a diblock copolymer.

A further aspect relates to the barrier above, wherein the diblock copolymer is a poly(styrene-ethylene/propylene) SEP copolymer.

A further aspect relates to the barrier above, wherein the SEP copolymer has a styrene content of 36% by weight or less.

A further aspect relates to the barrier above, wherein the viscosity modifier has a particle surface more developed than Septon 1020.

A further aspect relates to the barrier above, wherein the viscosity modifier is Kraton G1702.

A further aspect relates to the barrier above, wherein the polymer is comprised in a polymer blend, wherein the polymer blend is the viscosity modifier.

A further aspect relates to the barrier above, wherein the polymer blend comprises Kraton G1702 with one or more of Kraton G1652, Kraton G1650, Europrene SOL TH 2312, and Europrene SOL TH 2315.

A further aspect relates to the barrier above, wherein the viscosity modifier is Kraton MD6953 or Kraton G1750.

A further aspect relates to the barrier above, wherein an additive is comprised in the viscosity modifier.

A further aspect relates to the barrier above, wherein the additive is a glidant.

A further aspect relates to the barrier above, wherein the glidant is silica.

A further aspect relates to the barrier above, wherein the glidant is about 1 to 5% by weight of the silica.

A further aspect relates to the barrier above, wherein the glidant is about 2% by weight of the silica.

A further aspect relates to the barrier above, wherein the silica is Syloid™ 244.

A further aspect relates to the barrier above, wherein the silica is Aerosil™ R972.

A further aspect relates to the barrier above, wherein the additive is a lubricant, partitioning agent, or excipient.

A further aspect relates to the barrier above, wherein the particle size of the viscosity modifier is 300 μm to 1 mm.

A further aspect relates to the barrier above, comprising a minimum of 1.2 kg/m² of the viscosity modifier.

A further aspect relates to the barrier above, wherein the viscosity modifier is comprised in a layer, and the minimum thickness of the layer is 1 mm.

A further aspect relates to the barrier above, wherein the viscosity modifier is a tackifier.

A further aspect relates to the barrier above, wherein the viscosity modifier is a wood resin.

A further aspect relates to the barrier above, wherein the wood resin is a rosin resin.

A further aspect relates to the barrier above, wherein the viscosity modifier is aluminum stearate, a hydrogenated vegetable oil, or an ethylene propylene diene monomer (EPDM) terpolymer.

A further aspect relates to the barrier above, wherein the barrier further comprises a textile fabric.

A further aspect relates to the barrier above, wherein the barrier comprises a bottom and a top layer of the textile fabric sandwiching a layer of the viscosity modifier, and the layers are needle-punched together.

A further aspect relates to the barrier above, wherein the viscosity modifier dissolves or mixes into the liquid hydrocarbon in less than one minute.

A further aspect relates to the barrier above, wherein the viscosity modifier dissolves or mixes into the liquid hydrocarbon in less than about 15 seconds.

In a further aspect, the invention relates to a set of barriers for containing or reducing a leak of liquid hydrocarbon, comprising the barrier of above, and comprising a further barrier positioned to contact the liquid hydrocarbon before the barrier comprising the viscosity modifier.

A further aspect relates to the set of barriers above, wherein the further barrier comprises an absorbent or polymer gel.

A further aspect relates to the set of barriers above, wherein the absorbent or polymer gel is a powder or granulate.

A further aspect relates to the set of barriers above, wherein the absorbent or polymer gel is at least one of hydrogenated poly(styrene-ethylene/propylene) (SEP) copolymers, hydrogenated poly(styrene-isoprene-styrene) (SEPS) copolymers, hydrogenated poly(styrene-butadiene-styrene) (SEBS) copolymers, hydrogenated poly(styrene-isoprene/butadiene-styrene) (SEEPS) copolymers: EPDM rubbers in powdered or granular form; aluminum soaps of naphtenic and palmitic acids (such as aluminum octoate) in powdered or granular form; and modified polyamide hydrocarbon gellants and resin blends.

A further aspect relates to the set of barriers above, wherein the gellants and resin blends are at least one of ester-terminated polyamides, tertiary amide terminated polyamides, ester-terminated poly(ester-amides), polyalkyleneoxy-terminated polyamides and polyether polyamides.

A further aspect relates to the set of barriers above, wherein the absorbent or polymer gel is at least one layer of a hydrogenated poly(styrene-ethylene/propylene) (SEP) copolymer, a hydrogenated poly(styrene-b-isoprene-b-styrene) (SEPS) copolymer, a hydrogenated poly(styrene-b-butadiene-b-styrene) (SEBS) copolymer, and a hydrogenated poly(styrene-b-isoprene/butadiene-b-styrene) (SEEPS) copolymer.

A further aspect relates to the set of barriers above, wherein the surface density of the absorbent or polymer gel is in the range from 10 g/m² to 5,000 g/m².

A further aspect relates to the set of barriers above, wherein the further barrier comprises a bottom and a top layer of textile sandwiching a layer of the absorbent or polymer gel, and the layers are needle-punched together.

In another aspect, the present invention relates to an oil spill containment system for containing oil spills or leaks from an oil containing vessel, comprising: a containment basin, a barrier of viscosity modifier contained within the basin; a barrier of oil-absorbing material also contained within the basin, on top of the barrier of viscosity modifier, and wherein the layer of viscosity modifier when contacted with oil, forms a viscous fluid which prevents oil and water from passing through.

A further aspect relates to an oil spill containment system of above, wherein the barrier of the viscosity modifier is defined in above.

A still further aspect relates to an oil spill containment system of above, wherein the barrier of oil-absorbing material is the further barrier as defined in above.

Another aspect of the invention relates to an oil spill containment system for containing oil spills or leaks from an oil containing vessel, comprising: a containment basin, a barrier of viscosity modifier contained within the basin, wherein the viscosity modifier is Kraton G1702 and about 2% silica; a barrier of oil-absorbing material also contained within the basin, on top of the barrier of viscosity modifier, and wherein the layer of viscosity modifier when contacted with oil, forms a viscous fluid which prevents oil and water from passing through.

Other aspects and features of the present invention will become apparent to those ordinarily skilled in the art.

### BRIEF DESCRIPTION OF THE DRAWINGS

Embodiments of the invention will now be described in greater detail with reference to the accompanying figures, in which:

FIG. 1A is a schematic drawing of an exemplary embodiment of a liquid hydrocarbon containment system containing a single textile barrier in accordance with some embodiments of the present invention.

FIG. 1B is a schematic drawing of an exemplary embodiment of a liquid hydrocarbon containment system containing two textile barriers in accordance with some embodiments of the present invention.

FIG. 2A is a cross-sectional view of an embodiment of a textile barrier for the containment of liquid hydrocarbons in accordance with some embodiments of the present invention.

FIG. 2B is a cross-sectional view of an embodiment of a textile barrier which may be used with the embodiment of FIG. 2A.

FIG. 3 is a schematic drawing of an embodiment of a method of manufacturing a textile barrier used for the containment of liquid hydrocarbons.

FIG. 4 is a drawing showing a small rig used in a Level 2 test for determining whether a test substance is potentially useful for containing liquid hydrocarbons.

FIG. 5 is a photograph of a sample of textile barrier fabric after a Level 3 test.

FIG. 6 is a photograph of a cross-section of a sample, folded in half (with the clean sides together), from textile barrier fabric after a Level 3 test.

FIG. 7 is a drawing showing a bucket used for longer-term testing of a textile barrier.

In the above figures, dimensions of components are chosen for convenience and clarity only and are not necessarily shown to scale.

### DETAILED DESCRIPTION

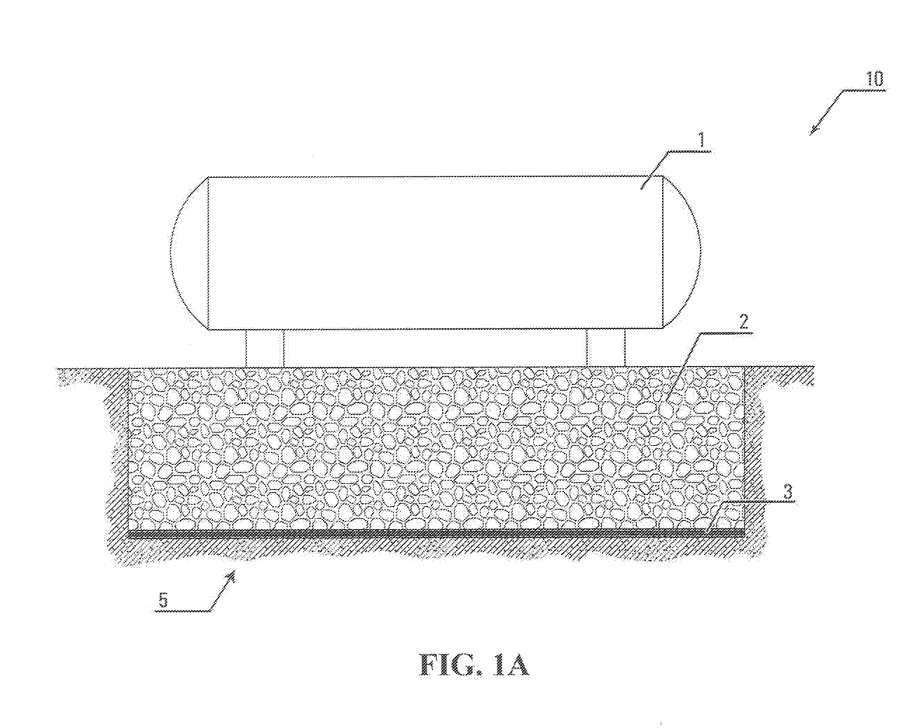

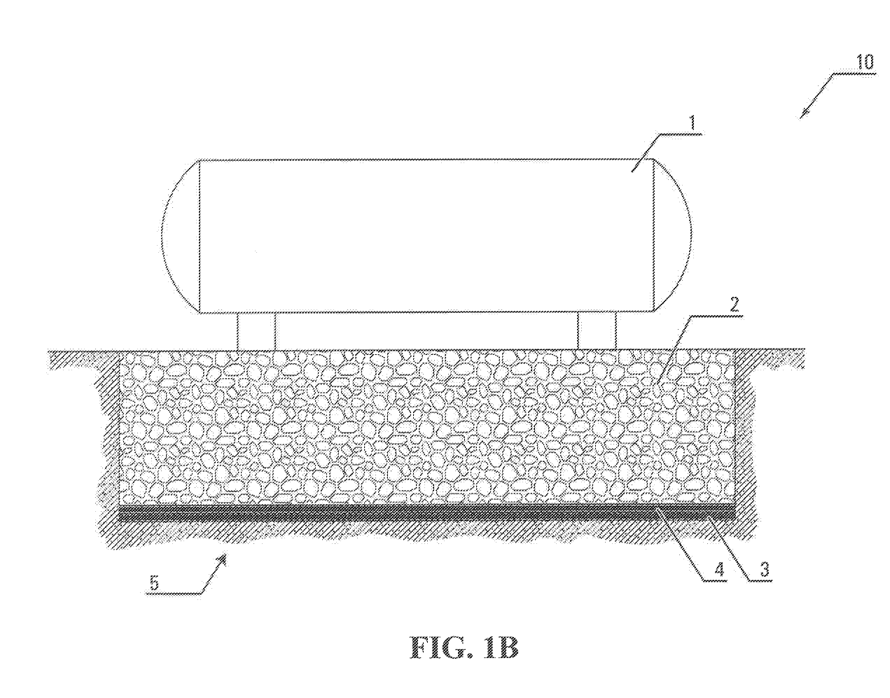

FIGS. 1A, 1B, 2A and 2B illustrate features of a system for the containment of liquid hydrocarbons. It should be appreciated that the embodiments shown in FIGS. 1A, 1B, 2A and 2B are intended solely for illustrative purposes, and that the present invention is in no way limited to the particular example embodiments explicitly shown in the drawings and described herein.

FIG. 1A is a schematic diagram of a representative example of a containment site 10 where a textile barrier 3 can be used. In this embodiment, the textile barrier 3 is shown being deployed beneath a ground liquid hydrocarbon storage source, which in this case is liquid hydrocarbon storage tank 1. Although textile barrier 3 is depicted as being flat, the whole of textile barrier 3 or a part of it may be angled or even vertical relative to the ground surface. Further, textile barrier 3 may be produced in different shapes and sizes.

Containment site 10 is comprised of storage container 1 for holding liquid hydrocarbons such as oil, gasoline, diesel fuel and/or other petroleum products. In one embodiment, the liquid hydrocarbon is a transformer oil such as Hyvolt™ II (from Ergon™ Refining), Luminol™ TRI (from PetroCanada™), or others. Beneath storage container 1 is a spill collection basin 2 that may be utilized to retain hydrocarbon spills and leaks originating with storage container 1.

Spill collection basin 2 is usually filled with a porous material or a mixture of porous materials (for instance, crushed stones or sand). The filling material may be placed in layers in the spill collection basin. For instance, there may be a layer of sand directly on top of the textile barrier, then a layer of one type of stone atop the sand layer, followed by a layer of another type of stone. Spill collection basin 2 is usually filled to the top of the ground surface. In one embodiment, the spill collection basin is two to three feet deep.

At the bottom of spill collection basin 2 is textile barrier 3. The construction of textile barrier 3 will be described in connection with FIG. 2A. Hydrocarbon spills and leaks of storage container 1 fall into spill collection basin 2. Due to the porous nature of the filling material in spill collection basin 2, there is void space to receive spilt or leaking liquid hydrocarbon. The spilt or leaked liquid hydrocarbon eventually settles on textile barrier 3. As described in more detail below, the construction of textile barrier 3 prevents or reduces leakages of liquid hydrocarbons from escaping spill collection basin 2 while allowing rainwater to pass through to environment 5 if the textile barrier has not come into contact with significant amounts of liquid hydrocarbon.

Persons skilled in the art will appreciate that FIG. 1A is just one embodiment where textile barrier 3 can be used to contain liquid hydrocarbon spills and leaks. In some embodiments, textile barrier 3 can be deployed underneath electrical transformers and other electrical devices filled with oil, or beneath liquid hydrocarbon transportation pipelines.

In another embodiment, textile barrier 3 can be also deployed around underground hydrocarbon storage tanks or underground pipelines or another liquid hydrocarbon storage sites. In other embodiments, textile barrier 3 can be deployed around liquid hydrocarbon transfer sites (e.g. truck, railway or sea ports). In yet other embodiments, textile barrier 3 can be deployed directly on the ground or can be buried in soil being a part of a more complex containment system.

The list of possible applications for textile barrier 3 is not limited to the above mentioned and may include other sites that require protection from liquid hydrocarbon spills or leaks.

As discussed in greater detail below in connection with FIG. 2A, textile barrier 3 may comprise a layer of viscosity modifier, wherein the viscosity modifier increases the viscosity of the liquid hydrocarbon upon contact.

FIG. 1B is a schematic drawing of an exemplary embodiment of a liquid hydrocarbon containment system containing two textile barriers in accordance with some embodiments of the present invention. In FIG. 1B, textile barrier 4 is placed above textile barrier 3. Textile barrier 4 may be placed on top of textile barrier 3 so that they are in contact, as depicted in FIG. 1B. However, the invention is not limited to such an embodiment, as there may be a gap between the two barriers. The gap may be filled by another barrier, crushed rock or other material.

While FIG. 1B shows textile barrier 4 having the same horizontal surface area as textile barrier 3, the two textile barriers may have different surface areas. One textile barrier may have greater surface area than the other. Further, the shape of the textile barriers is not limited to continuous, flat surfaces. The whole or part of the textile barriers may be angled or even vertical relative to the ground surface. Each of the textile barriers may also be cut into different shapes and sizes. Still further, the textile barriers may be angled relative to each other.

Textile barrier 4 may comprise a chemical to help contain liquid hydrocarbons. This chemical may be, for instance, an absorbent. As discussed in greater detail below in connection with FIG. 2B, textile barrier 4 may comprise a layer of absorbent. However, the chemical may also be an adsorbent, another viscosity modifier, or a mixture of chemicals.

A liquid hydrocarbon leak into containment basin 2 will eventually settle on textile barrier 4. Textile barrier 4, if comprising an absorbent, will absorb the leaked liquid hydrocarbon while allowing water to pass through to textile barrier 3, even when it becomes saturated with liquid hydrocarbon. In the absence of significant contact with liquid hydrocarbon, textile barrier 3 will also allow water to pass through, and into the environment 5.

If and when textile barrier 4 becomes saturated with liquid hydrocarbon, any further liquid hydrocarbon may flow down to textile barrier 3. Viscosity modifier in the textile barrier 3 may then dissolve or mix into the liquid hydrocarbon and increase its viscosity, which may limit liquid hydrocarbon leakage into the environment 5.

If there are small and/or occasional leaks from storage tank 1, the absorbent in textile barrier 4 may reduce or prevent liquid hydrocarbon from contacting textile barrier 3. Textile barrier 3 may be very sensitive to small quantities (e.g. 100 L of transformer oil from a transformer insulated with 10,000 L) of liquid hydrocarbon. Textile barrier 4 may be removed and replaced periodically if it absorbs an occasional or small leak of liquid hydrocarbon, to spare textile barrier 3.

In one embodiment, the textile barrier 4 may comprise an absorbent that immobilizes up to 10:1 of its weight of liquid hydrocarbon. If, for instance, the amount of absorbent is about 3.0 kg/m², it may immobilize up to about 30 kg of liquid hydrocarbon. If 100 L of liquid hydrocarbon leaks or spills, it may be immobilized by 3 to 4 m² of the textile barrier, leaving textile barrier 3 intact.

It is noted that embodiments may include more than one each of barriers 3 and 4.

In some embodiments, there may be one or more additional layers comprising material that may chemically bind or deactivate other components of liquid hydrocarbons such as polychlorinated biphenyls (PCBs) and polycyclic aromatic hydrocarbons (PAHs). The additional layers may be placed so that they are located more proximate to the source of liquid hydrocarbon than the textile barriers.

As shown in connection with FIGS. 1A and 1B, the textile barriers may comprise a distinct chemical layer. In another embodiment, chemicals (such as viscosity modifiers or absorbents) may be included in an open cell foam structure of the textile fabric or by embedding particles of the chemicals into a layer of non-woven fabric. The latter may be accomplished by using, for instance, a dry impregnation process.

The following are more detailed descriptions of embodiments where the chemicals are comprised as a distinct layer within the textile barrier.

FIG. 2A depicts an embodiment where a textile barrier 21 is comprised of a layer 22 of viscosity modifier encapsulated between two layers of textile materials, the bottom (substrate) layer 23 and top (cover) layer 24.

FIG. 2B depicts an embodiment where a textile barrier 25 is comprised of a layer 26 of a different chemical (such as an absorbent) encapsulated between two layers of textile materials, the bottom (substrate) layer 27 and top (cover) layer 28. Such a textile barrier in conjunction with the embodiment of FIG. 2A.

In either or both textile barriers 21 and 25, at least one of the substrate layer and top layer may be made of a non-woven fabric, or at least a combination of non-woven and woven fabrics. The nonwoven component may allow the integration of the substrate layer and the cover layer during the needle-punching process.

The nonwoven fabric component may be constructed from loosely connected/interlocked fibers, which may be cut fibers with lengths ranging from 50 to 75 mm. During the needle-punching process, fibers from the nonwoven fabric (from the substrate layer or cover layer) are drawn by needles and anchored into the opposite textile layer. The opposite textile layer does not have to be nonwoven. It may be purely a woven structure. In one embodiment, the needling process comprises drawing the fibers from the top layer and anchoring them into the substrate layer. The needles may travel from top to bottom. However, needling systems exist where needles are on both sides of the fabric (top and bottom) and the needling process involves travelling from the top to bottom and bottom to top (either simultaneously or in two separate stages).

Viscosity modifiers are discussed in more detail below.

As shown in FIGS. 1A and 2A, a textile barrier may comprise a viscosity modifier. When a viscosity modifier is added to a solvent or fluid, such as a liquid hydrocarbon, it disperses into it and forms a mixture. As the fluid resistance to flow of the mixture is different from the original solvent or fluid, its viscosity is altered.

In some embodiments, the viscosity modifier may dissolve into the liquid hydrocarbon. As viscosity modifiers may be polymers, they may follow typical polymer dissolution behavior (Miller-Chou, B A. and J. L. Koenig. (2003). A review of polymer dissolution. Progress in Polymer Science, 28, pp. 1223-1270): “First, the solvent begins its aggression by pushing the swollen polymer substance into the solvent, and, as time progresses, a more dilute upper layer is pushed in the direction of the solvent stream. Further penetration of the solvent into the solid polymer increases the swollen surface layer until, at the end of the swelling time, a quasistationary state is reached where the transport of the macromolecules from the surface into the solution prevents a further increase of the layer.” The result may be a surface layer of the polymer during dissolution from the pure polymer to the pure solvent as follows: the infiltration layer, the solid swollen layer, the gel layer, and the liquid layer.

Some viscosity modifiers may fully dissolve as a solution into the liquid hydrocarbon upon contact, especially if there is a sufficient relative quantity of hydrophobic groups. It is noted that even though such viscosity modifiers fully dissolve, there may not be a saturation limit for the concentration of viscosity modifier that can dissolve into the liquid hydrocarbon. Other viscosity modifiers may not fully dissolve into solvents or fluids. For instance, fumed silica in a cosmetic formulation may form 3-dimensional clusters or agglomerates in the solvent.

As a result of contact between a viscosity modifier and a liquid hydrocarbon, the viscosity of the liquid hydrocarbon may increase. Addition of further liquid hydrocarbon may lead to decreasing viscosity, but the fluid remains more viscous than the liquid hydrocarbon by itself.

As viscosity is a measure of the friction of a fluid, the viscosity modifier increases the friction within the liquid hydrocarbon to effect an increase in its viscosity. Depending on the particular viscosity modifier, it may comprise compounds that dissolve into the liquid hydrocarbon and create resistance by blocking or restricting the movement of liquid hydrocarbon molecules, creating friction between the viscosity modifier and the liquid hydrocarbon molecules, and/or by electrostatic interaction (e.g. van der Waals forces) between the viscosity modifier and the liquid hydrocarbon molecules.

In some embodiments, a polymer which acts as a viscosity modifier of liquid hydrocarbon may be used. To determine whether a polymer may be used, the following factors may be considered. These are general factors only, and are not to be taken as absolute factors. The general factors are to be considered holistically to determine whether a polymer may act as a viscosity modifier of liquid hydrocarbon. The general factors may not be exhaustive.

The more a polymer self-crosslinks in liquid hydrocarbon, the less it may mix in liquid hydrocarbon, and therefore, it is less likely to be used as a viscosity modifier. The self-crosslinking may occur chemically through covalent bonds or physically through static forces, and may occur before and after contact with liquid hydrocarbon. For instance, many triblock copolymers may form self-crosslinks and be less soluble in liquid hydrocarbon than diblock copolymers which often do not form self-crosslinks. This is only a general tendency, however. For instance, despite being a triblock copolymer, Kraton™ G1652 partially dissolves into liquid hydrocarbon. It is also noted that some diblock copolymers may also form crosslinks. For instance, a formulation of poly(styrene-butadiene-styrene) (SBS) copolymer may act as a physically crosslinked elastomer, which may hinder its solubility or ability to mix into liquid hydrocarbon. However, the monomeric units in different diblock copolymers, poly(styrene-ethylene/propylene) (SEP) copolymers, do not significantly form self-crosslinks, so certain SEP copolymers formulations may potentially be viscosity modifiers of liquid hydrocarbon.

Another general consideration may be the relative content of certain monomers making up the copolymer. For instance, the inclusion of ring or cyclic structures in monomers (e.g. as in aromatic and naphthenic polymers) may not significantly increase viscosity. As another example, in SEP copolymer formulations, a higher hydrophobic aliphatic content may render the polymers more soluble or allow them to more rapidly and/or completely mix in transformer oils which often have a high proportion of aliphatic hydrocarbons and naphthenic hydrocarbons. For instance, SEP copolymers, which are copolymers of styrene, ethylene, and propylene, may be more soluble in such a liquid hydrocarbon if they have a greater aliphatic (ethylene and propylene) content. Conversely, SEP copolymers having a higher styrene content may be less soluble in such a liquid hydrocarbon content.

Polymer chain length may also affect whether a polymer may be used in the present invention. A polymer with a longer chain length may increase the viscosity of liquid hydrocarbon more than a polymer with a shorter chain length. However, if the polymer chain length becomes too long, it may aggregate or self-coil and therefore have less effect on viscosity. A polymer with a shorter chain length may have a lesser tendency to aggregate or self-coil, but may have less of an impact on viscosity.

The average molecular weight is related to polymer chain length. A polymer with a very high average molecular weight may not dissolve or mix into the liquid hydrocarbon and may instead absorb the liquid hydrocarbon. With decreasing average molecular weight, a polymer may generally have a greater tendency to dissolve or mix, and dissolve or mix faster, in liquid hydrocarbon. However, a polymer having a molecular weight which is too low may not increase viscosity, and therefore, act as a viscosity modifier.

Observations regarding the triblock poly(styrene-ethylene/butadiene-styrene) (SEBS) copolymers provide an example of how average molecular weight may affect whether it may be used as a viscosity modifier. Kraton™ G1652, having a relatively low molecular weight, may partially dissolve in Hyvolt™ II transformer oil. Kraton™ G1650, having a medium/low molecular weight, may absorb the oil and form an elastic gel. Finally, Kraton™ G1654, having a medium/high molecular weight, may absorb the oil and not form a gel.

In one embodiment, the viscosity modifier is a formulation or composition of a poly(styrene-ethylene/propylene) (SEP) copolymer. In a further embodiment, the styrene content is 28% by weight. An example of such a formulation is Kraton™ G1702.

Certain tackifiers may be viscosity modifiers of liquid hydrocarbon. Tackifiers modify adhesive polymer matrices. Tackifiers are typically resins having low molecular weights (300 to 2000 Daltons) which may be compatible or partly compatible with rubber/elastomer or adhesive base polymers, and have glass transition temperatures higher than that of the rubber/elastomer or base polymer. In addition to increasing the viscosity of the liquid hydrocarbon, a tackifier contacted with a liquid hydrocarbon may result in the viscous fluid sticking to a textile layer, thereby further immobilizing the liquid hydrocarbon. In one embodiment, the viscosity modifier is a tackifier which is a natural wood resin such as rosin.

In another embodiment, a viscosity modifier is a thickener used in the cosmetic industry, such as aluminum stearate or hydrogenated vegetable oil (such as Dermofeel™ viscolid). In yet another embodiment, a powdered or granulated EPDM (ethylene propylene diene monomer) terpolymer formulated as a viscosity modifier is used in the present invention. In yet another embodiment, Kraton MD6953 and G1750 may be used as thickeners.

The viscosity modifier may also be a blend of polymers. Polymer blends may be helpful in lowering cost if certain ingredients are costly or difficult to obtain. In some embodiments, the viscosity modifier is a blend of Kraton™ G1702 with a different viscosity modifier or other chemical species or compounds. In some embodiments, the Kraton™ G1702 is mixed with one or more of the following: Kraton™ G1652, Kraton™ G1650, Europrene™ SOL TH 2312, and Europrene™ SOL TH 2315. Kraton™ G1702 may be present in the blends in a variety of different percentages by weight. In some embodiments, the amount of Kraton™ G1702 in these blends is 25%, 50%, or 75% by weight.

In some embodiments, the viscosity modifier may be in powder or granulate form. A powder or granulate may have a surface area sufficient to dissolve into the liquid hydrocarbon, yet allow water to pass through and be retained in a textile fabric.

Viscosity modifiers which rapidly disperse into liquid hydrocarbon may be more effective in immobilizing leaking liquid hydrocarbon. In this regard, a general factor to consider is the particle surface area, or particle surface “development” (which may also be an indication of porosity) of the viscosity modifier. One method of comparing surface area or surface development, at least for chemically similar species, is to compare the relative volumes per weight of species, with a higher volume per weight indicating greater surface area (or a more well-developed surface). Particle surface area or development can also be measured or compared using the dispersion factor DP=log₂(πab), where a and b are major and minor axes of a Legendre Ellipse, with higher DP values indicating greater surface area or surface development. Compositions that have less surface area or less developed surfaces may dissolve less rapidly into liquid hydrocarbons. For instance, Septon™ 1020, which is an SEP copolymer formulation, may form particles that are less developed on average than Kraton G1702. It is observed that Kraton G1702 has more volume than the same mass of Septon 1020. Reduced surface area or surface development may lead to considerably longer times to affect the viscosity of the liquid hydrocarbon. For instance, Septon 1020 may take 30 minutes to 1 hour to immobilize a transformer oil and may take several hours to fully dissolve into it.

Another general factor which may determine dissolution time is the relative monomer composition of a polymer. For example, Kraton™ G1702, which is an SEP copolymer composition comprising 28% by weight of styrene may dissolve rapidly (i.e. less than one minute) into transformer oil, but Kraton™ G1701, which is also an SEP copolymer composition but having 37% by weight of styrene, may take longer than one minute to dissolve.

In one embodiment, the viscosity modifier is a formulation or composition of a SEP copolymer having a surface more developed than Septon 1020. In another embodiment, the viscosity modifier is a SEP copolymer composition having a styrene content of around 36, 35, 34, 33, 32, 31, 30, 29, 28 or less (in percentages by weight). In a further embodiment, the formulation is Kraton G1702.

The physical form of the polymer may be a factor in determining ease of handling. Flowability may be ranked on a scale from free-flowing to non-flowing. A free-flowing powder is one that does not significantly clump and/or aggregate. A free-flowing powder may be transported pneumatically in high volume. One method of measuring powder flowability is to use ASTM B213-13, where a powder may be considered acceptable if, for instance, 200 g of powder freely flows through a funnel in less than 10 seconds. If the polymer is not available as a free-flowing powder or granulate, it may not be effectively utilized in the containment system.

If the polymer is a powder or granulate but forms clumps or aggregates, an additive may be included. The additive may be a lubricant, glidant, partitioning agent or excipient. Examples of lubricants include graphite powder, boron nitride powder, oils (such as silicone oil), waxes, and stearates. Examples of glidants include silica, talc, calcium phosphate, fly ash, sodium silicoaluminate, tarch, and boric acid. The additive may coat the particles of the polymer, but a high concentration of additive may decrease solubility or ability to mix into the liquid hydrocarbon.

The glidant, partitioning agent or excipient may coincidentally be a thixotropic agent. Silica is an example of an additive which is both a glidant and a thixotropic agent. As a glidant, it may allow the polymer to have a reduced clumping or aggregating tendency so that it may, for instance, be pneumatically transported in a production system. As a thixotropic agent, the silica may make the polymer more thixotropic in the liquid hydrocarbon. This may allow the polymer in liquid hydrocarbon to be better contained in a textile barrier and thereby reduce or prevent liquid hydrocarbon leakage.

In an embodiment, the additive is silica. In an embodiment, the viscosity modifier is combined with an additive. In a further embodiment, an SEP copolymer with around 28% by weight styrene and which forms porous particles is combined with 1 to 5% by weight of silica (for greater certainty, this includes around 1%, 2%, 3% 4% or 5% of silica) or with around 2% by weight of silica. The silica may cause the SEP copolymer powder or granulate to form less solid aggregates. In a further embodiment, the viscosity modifier is Kraton G1702 and the additive is 1 to 5% (for greater certainty, this includes around 1%, 2%, 3% 4% or 5% of silica) or around 2% by weight Syloid™ 244 or Aerosil™ R972.

In one embodiment, the viscosity modifier is a powder or granulate with a particle size of 300 μm to 1 mm. It may be that a finer particle size makes the reaction with the liquid hydrocarbon faster, but may make processing the material less convenient because the powder or granulate may form more aggregates and therefore be less free-flowing.

In one embodiment, the viscosity modifier (with or without additive) may mix into the liquid hydrocarbon in less than one minute and raise its viscosity. In another embodiment, the viscosity modifier may mix in about 15 seconds or less into the liquid hydrocarbon. When the viscosity modifier contacts leaking liquid hydrocarbon, there may be immobilization of the latter because it increases in viscosity, leading to significantly reduced initial leakage of liquid hydrocarbon in a containment system.

In one embodiment, where water is expected to pass through the layer of viscosity modifier, the viscosity modifier is water-insoluble and not carried away by passing water.

When contacted with liquid hydrocarbon, the viscosity modifier layer may form a gradient of liquid hydrocarbon concentration across its cross-section, with the liquid hydrocarbon at its highest concentration near the point of contact with the viscosity modifier. The gradient may disappear or be reduced gradually, resulting in more uniformity.

The textile allows the liquid hydrocarbon to seep through to the viscosity modifier layer, but may block the viscosity modifier from escaping outside the viscosity modifier layer. Thus, viscosity modifier sandwiched between textile layers may not become dilute or disperse into transformer oil outside the viscosity modifier layer.

In one embodiment, contact between the viscosity modifier with the leaking liquid hydrocarbon results in a fluid. The resulting fluid may not be an elastic solid, and may instead be a fluid which has more viscosity than the liquid hydrocarbon. This fluid may help block further entry of liquid hydrocarbon into the viscosity modifier layer.

If the liquid hydrocarbon is a transformer oil, the latter should generally not exceed 65° C., as noted in NEMA (National Electrical Manufacturers Association) standard C57.12.22. The transformer storage container should withstand at least 105° C. In one embodiment, the viscosity modifier layer prevents transformer oil at 65° C. or lower from passing through, and may also prevent transformer oil at higher temperatures from passing through.

In one embodiment, a textile barrier such as that illustrated in FIG. 2A may include a minimum of 1.2 kg/m² of viscosity modifier. In another embodiment, there is about 2.5 kg/m² of viscosity modifier. In one embodiment, the layer of viscosity modifier is a minimum of 1 mm in thickness.

As illustrated in FIG. 1B, a further textile barrier may be used. This further textile barrier may comprise an absorbent or polymer gel which absorbs liquid hydrocarbon, another viscosity modifier, an adsorbent, other chemical, or a mixture of chemicals. In one embodiment, the further textile barrier comprises an absorbent or polymer gel.

As a result of contact between an absorbent or polymer gel and liquid hydrocarbon, the liquid hydrocarbon may move into the molecular structure of the absorbent or polymer gel. Liquid hydrocarbon dissolves into absorbents and polymer gels, which may cause them to swell. Absorbents and polymer gels may therefore be referred to as organic swellable chemicals. The IUPAC definition of ‘Gels’ states: “Nonfluid colloidal network or polymer network that is expanded throughout its whole volume by a fluid”. After a saturation limit is reached, excess liquid hydrocarbon will not be absorbed into the absorbent or polymer gel, and the excess will exist as a separate phase.

A textile barrier comprising absorbent may be positioned such that liquid hydrocarbon contacts this barrier before the textile barrier comprising viscosity modifier. See, for example, FIG. 1B. The absorbent barrier may protect the viscosity modifier barrier from immediate contact with small quantities (e.g. 100 L of transformer oil from a transformer insulated with 10,000 L) of liquid hydrocarbon. Such small quantities may be produced by small and occasional leaks. If and when the absorbent or polymer gel barrier becomes saturated, excess liquid hydrocarbon will flow out/down to the textile barrier containing viscosity modifier.

An absorbent or polymer gel may be capable of absorbing large volumes of liquid hydrocarbon (such as transformer oil), in some cases up to 10 times its original weight. In one embodiment, 1 m² of the chemical may absorb and hold up to 20 L of transformer oil. A typical chemical may weigh about 3.0 kg/m² and immobilize up to about 30 kg of oil.

An example of an absorbent or polymer gel used in the chemical layer 26 of FIG. 2B is a hydrogenated poly(styrene-ethylene/butadiene-styrene) (SEBS) copolymer. The SEBS copolymer may form a cross-linked gel with a liquid hydrocarbon. The cross-linked structure may slowly expand as oil is absorbed. Molecules of the solvent may become trapped between the polymer chains. This may cause the polymer to swell and form a material having elastic and/or plastic properties. For instance, the material may keep its shape and resemble a soft rubber ball. More solvent can be added, but a saturation limit may be encountered. If and when saturation is reached, no more solvent may enter. The end result may then be a swollen polymer and excess solvent. The SEBS copolymer may expand slowly, so that absorption of liquid hydrocarbon may take at least one minute. In the meantime, liquid hydrocarbon may initially leak if contacted with the copolymer.

There are a variety of chemicals that may be used to absorb liquid hydrocarbon. These include hydrophobic swellable polymers selected from hydrogenated poly(styrene-ethylene/propylene) (SEP) copolymers, hydrogenated poly(styrene-isoprene-styrene) (SEPS) copolymers, hydrogenated poly(styrene-butadiene-styrene) (SEBS) copolymers, hydrogenated poly(styrene-isoprene/butadiene-styrene) (SEEPS) copolymers; EPDM rubbers in powdered or granular form; aluminum soaps of naphtenic and palmitic acids (such as aluminum octoate) in powdered or granular form; modified polyamide hydrocarbon gallants and resin blends and mixtures of all the above if not formulated as viscosity modifiers. It is noted that SEP, SEPS, SEBS, and SEEPS copolymers may be competitive in terms of price per performance.

The gellants and resin blends may be, for example, light-coloured polyamides. Examples include ester-terminated polyamides, tertiary amide terminated polyamides, ester-terminated poly(ester-amides), polyalkyleneoxy-terminated polyamides and polyether polyamides. The polyamides may also be, for example, vegetable based or vegetable-dimer based. An exemplary gellant comprises an ethylenediamine/stearyl dimer dilinoleate copolymer. A number of proprietary gellants and resins are commercially available, such as those available from Arizona Chemical and sold under the trademarks UNICLEAR™, SYLVAGEL™, SYLVACLEAR™ and SYLVACOTE™ in powder or granular form. Without limitation, and by way of example, proprietary, commercially available gellants include. SYLVAGEL™ 5000, SYLVAGEL™ 5100, SYLVAGEL™ 6000, SYLVAGEL™ 6100, SYLVACLEAR™ A200, SYLVACLEAR™ A2635, SYLVACLEAR™ A2614, and SYLVACLEAR™ C75V.

In one embodiment, multiple absorbent or polymer gel barriers are used to absorb leaks of liquid hydrocarbon. These barriers may be removed and replaced without affecting the integrity of the containment system and affecting the underlying textile barrier containing viscosity modifier. This may increase the useful lifetime of the containment system as a whole.

Liquid hydrocarbon trapped in an absorbent or polymer gel barrier may not be displaced by water as quickly as in an adsorption barrier. The absorbent or polymer gel barrier, even if saturated with liquid hydrocarbon, may not obstruct the flow of water and the draining capabilities of the containment system.

The absorbent or polymer gel may be in a granulated or powdered form.

In one embodiment, at least 95% of the particles (of a granulated or powdered form) pass through Standard Sieve Size 5.6 mm, also known as Sieve No. 3 (ASTM E11-04).

The surface density of the absorbent or polymer gel between the substrate layer and cover layer in a textile barrier (such as that shown in FIG. 2B) is in direct relation to the swelling capacity of the absorbent or polymer gel and the required hydrocarbon retention. In one embodiment, the surface density of the absorbent or polymer gel is in the range from 10 g/m² to 5,000 g/m². In one embodiment, the surface density of absorbent or polymer gel is in the range from 1,500 g/m² to 3,000 g/m².

A discussion of how textile barriers may be assembled is discussed below.

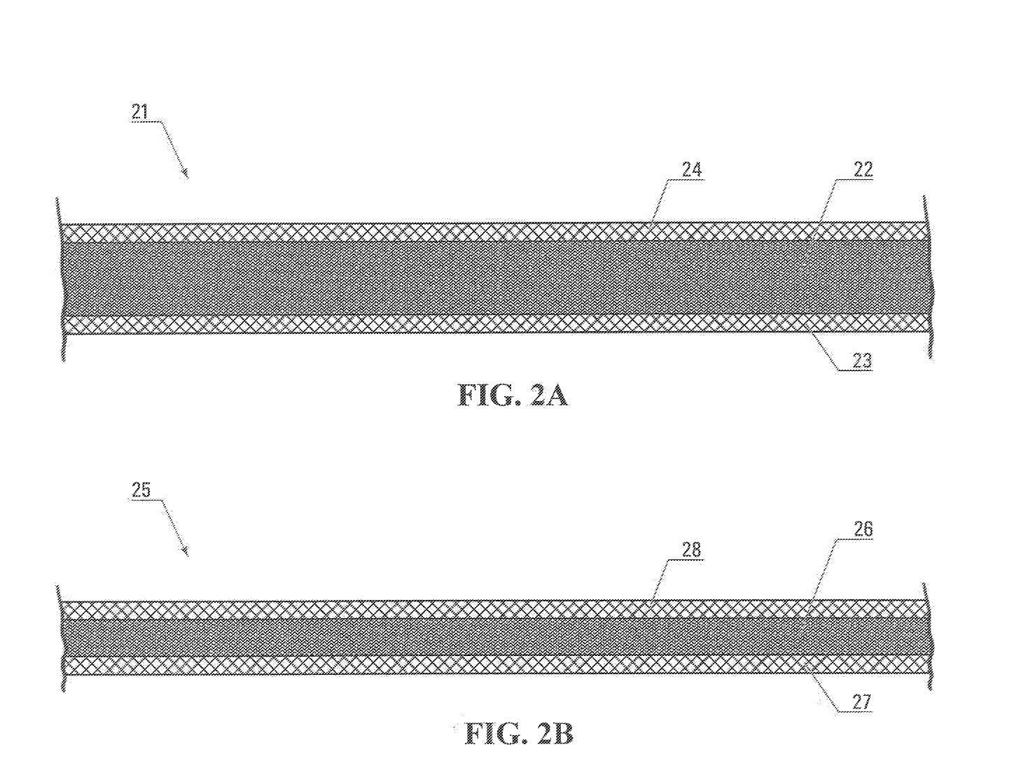

FIG. 3 illustrates an embodiment of a method of manufacturing a textile barrier. The method may comprise the following steps:
(a) spreading the substrate layer 33 of the textile barrier 31;
(b) distributing a layer 32 comprising a chemical on top of the substrate layer 33;
(c) covering the layer of (b) with a cover layer 34; and
(d) assembling the textile barrier by needle-punching process in a needling loom.

In one embodiment, the layer 32 comprises viscosity modifier and therefore depicts a method of manufacturing a textile barrier comprising viscosity modifier. FIG. 3 is not limited to textile barriers comprising viscosity modifiers, however. For instance, in another embodiment, the layer 32 comprises absorbent, and therefore, FIG. 3 may depict a method of manufacturing a textile barrier comprising an absorbent.

In summary, an embodiment of the method is as follows. A roll of a textile material is placed on reel 31 and is guided into a needling loom as a substrate 33. A predetermined amount of a material 32 is fed by means of a dispensing system 32 on top of the moving substrate forming a continuous layer of predetermined surfaced density and thickness on top of the substrate 33. Such composition is covered with a layer of the cover textile material 34, dispensed from reel 33. The three layers (substrate layer 33, material layer 32 and cover layer 34) are joined together by a needle-punching process carried out in needling loom 34. The needle-punching process makes multiple individual holding fibers to extend through the layer of the chemical and to anchor into the substrate layer.

In one embodiment, the needle-punching process may result in the substrate layer and the top layer being connected together in a strong and permanent way such that they do not fall apart easily when one layer (substrate or cover) is subject to movement and the opposite layer does not move. The mechanisms of connecting the substrate layer 33 and the top layer 34 may rely on the fact that fibers from a nonwoven fabric are pushed through the layer 32 and mechanically anchored in the opposite later of textile material which may be nonwoven or woven.

More details of the embodiment of the method described above are discussed below.

The bottom (substrate) layer of the textile material 33 may be unwound from roll 31 and first guided to the chemical distribution. The distribution system covers the substrate layer 33 with a layer of the chemical 32. The substrate layer 33 with the layer 32 of the chemical is then covered with a top (cover) layer 34 of textile material. The structure (comprising substrate layer 33, chemical 32 and cover layer 34) is guided to a needling loom 34 and subjected to a needle-punching process in the needling loom. In the needle-punching process, top and bottom layers 33 and 34 of the assembly are joined together by fibers drawn from the top (cover) layer 34 and anchored into the bottom (substrate) layer 33, producing a uniform textile structure with layer 32 of chemical inside the structure.

Fibers that extend from top layer 34 and anchor into substrate layer 33 may form a mechanical bond between layers interlocking the chemical 32 between textile layers 33 and 34.

The mechanical bond formed by the fibers from the top layer 34 interlocked in the needling process with the fibers of the substrate layer 33 may provide a counteracting action against any pressure from the chemical interacting with the liquid hydrocarbon. There may be strong and permanent mechanical containment of the chemical between the two textile layers 33 and 34.

The substrate layer 33 and cover layer 34 may be non-woven textile material, woven fabric and knitted fabric, or any combination of thereof. At least one of the substrate layer 33 and the cover layer 34 may be comprised fully or partially of a non-woven textile material.

The applied non-woven textile materials (both the bottom substrate and the top layer) may have surface weights in the range from 10 g/m² to 1.000 g/m² each. In one embodiment, the surface weight of the textile material is in the range from 200 g/m² to 400 g/m² each.

The applied non-woven textile material may be a non-woven, needle-punched fabric produced from polypropylene, polyester (PET) or other synthetic or natural fibers or fiber blends, having total thickness from 0.1 mm to 10 mm. The non-woven textile material may be previously attached by chemical, thermal or mechanical bonding method of needle-punching to a reinforcing woven fabric (“scrim”). This may lead to improved dimensional stability and tensile strength.

The above embodiments may be deployed in conjunction with hydrocarbon storage tanks, pipelines or other liquid hydrocarbon storage sites. It may be deployed around liquid hydrocarbon transfer sites (e.g. truck, railway or sea ports), directly on the ground or it may be buried in soil being a part of a more complex containment system. The possible applications of the multiple barrier system are not limited to the above mentioned and may include other sites that require protection from liquid hydrocarbon leaks. In one embodiment, the source of liquid hydrocarbon is a transformer insulated with transformer oil.

In one embodiment, the method is fully automated and does not require supervised operation, does not require a power supply, and does not require maintenance. In another embodiment, there is a simplicity and low cost of deployment, as well as high water permeability. It may allow drainage of large quantities of rainfall water while the bottom textile barrier has not been contacted with liquid hydrocarbon. In yet another embodiment, there may be resistance to plugging, ability to filter out small hydrocarbon leaks from large volume of rain water, and quick response time to catastrophic hydrocarbon spills.

In one embodiment, shear forces may be transferred from one textile layer to the other. For example, on a sloped surface, shearing forces may be transmitted by the covering layer through the layer of chemical into the bottom layer. In this embodiment, the covering layer and bottom layer are mechanically connected and may not slide if the whole assembly is put vertically. The textile barrier may lie at the bottom of the containment basin but also cover sidewalls vertically or at a vertical angle. The side of the textile layer that contacts the ground/soil may anchor itself to the surface of the soil by mechanical friction forces, for example. However, the covering layer may be exposed to shear forces acting in the downward direction. Without a mechanical connection between these layers, the covering layer may slide down. The mechanical connection between these layers may transfer the shear forces acting on one side of the covering layer to the other side of the covering layer. Since the other side of the covering layer is mechanically anchored to the soil layer, the entire structure may remain intact.

### Experimental Section

This section provides examples of experiments and results of particular embodiments of the invention only. It will be understood that this section is not to be construed as limiting the scope of the invention. In particular, where examples of the invention are presented, they are not to be construed as limiting the invention to those examples.

### Level 1 Test

This is test can determine whether a test substance, when mixed with transformer oil, acts as a viscosity modifier which rapidly contains transformer oil. An amount of 5 g of the test substance is placed in a small container and 25 g of transformer oil is quickly added to the test substance. The contents are mixed for 30 seconds and then left undisturbed for 30 seconds. The container is turned upside-down. If the mixture stays in the container, the test substance proceeds to the next test.

It was found that a composition comprising Kraton G1702 with 2% by weight of silica, when mixed with transformer oil, did not flow out of the container in this test. A similar composition comprising Kraton G1701 did not proceed to the next test.

### Level 2: Small Rig Test

This test can determine whether a test substance, when placed in a barrier fabric, may be used for containing spills of liquid hydrocarbon.

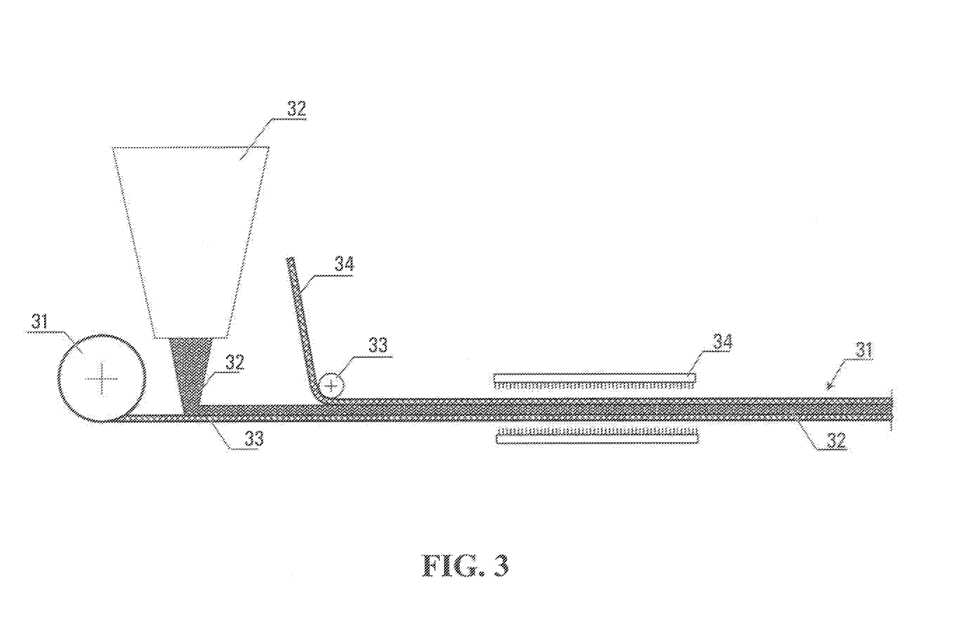

A disk of 57 mm is cut out from a polypropylene non-woven needle-punched fabric (e.g. Albarrie 600R) and placed at the bottom of a small rig as shown in FIG. 4. A predetermined amount of test substance is uniformly distributed on the surface of the fabric disk. The test substance is covered with another disk of 57 mm cut out from another polypropylene non-woven needle-punched fabric. This trilayer forms the sample fabric.

It is noted that FIG. 4 depicts only one barrier for testing, but it is noted that the present invention is not limited to only one barrier, as explained elsewhere in the application.

The small rig is closed. The top part of the small rig is designed such that it exerts pressure along the edge of the assembled sample fabric and prevents liquid hydrocarbon from flowing around the edge. The liquid hydrocarbon used was Hyvolt II transformer oil or Luminol TRI transformer oil. Liquid hydrocarbon, dyed blue, is poured into the small rig until it reaches the top. A cup placed under the rig collects leaked liquid hydrocarbon.

If any liquid hydrocarbon visibly leaks from the small rig through the sample fabric, the test substance does not proceed to the next test. If the bottom fabric disk of the sample fabric has been visibly exposed to any liquid hydrocarbon, the test substance does not proceed to the next test.

For the test substance to proceed to the next test, there must be no visible leakage, and the bottom, external side of the supporting fabric disk must not be visibly exposed to any liquid hydrocarbon during the test period of 72 hours. A test substance is considered highly effective if only 3 g of the test substance is required to pass the test.

A composition comprising Kraton G1702 and 2% by weight Syloid 244 was used as the test substance. First, 6.00 g (2.35 kg/m²) of the test substance was found to succeed with both Hyvolt II and Luminol TRI. The amount of the test substance still succeeded at the progressively lower amounts of 5.00 g (1.96 kg/m²), 4.00 g (1.57 kg/m²), and 3.00 g (1.18 kg/m²). Therefore, the composition of Kraton G1702 and 2% by weight of Syloid 244 was found to be highly effective. An amount lower than 3.00 g was not tested because it is difficult to spread such a low amount of composition evenly over the disk surface.

It is also noted that compositions comprising Kraton G1702 and 1%, 2%, 3%, 4%, and 5% of Aerosil R972, as well as compositions comprising Kraton G1702 with 1%, 3%, 4%, and 5% of Syloid 244 also passed the test at 3 g with both Hyvolt II and Luminol TRI.

All successful compositions (those that passed at 3 g) were tested for powder flowability. The test was devised based on ASTM B213-13. A laboratory lab funnel with an opening of about ½ in. was used. It was assumed that a sample is acceptable if 200 g of powder freely flows through the funnel in less than 10 seconds. It was found that samples of Kraton G1702 with 2%, 3%, 4%, and 5% of Syloid 244 passed the test, and that there was no observed difference between the flowability at 3%, 4%, and 5%. Further, samples of Kraton G1702 with 1%, 2%, 3%, 4%, and 5% of Aerosil R972 passed the test, but each created higher dust contamination as compared with the Syloid 244 samples.

Finally, it is noted that other test substances were tested and found to succeed at 6 g. but were not tested at lower weights. These test substances were blends with Kraton G1702: with Kraton G1652, with Kraton G1650, with Europrene SOL TH 2312, and with Europrene SOL TH 2315. The concentration of Kraton G1702 in these blends was 25%, 50%, and 75%.

### Level 3: Large Rig Test

This test can determine whether a test substance, when placed in a needle-punched barrier fabric, may be used for containing spills of liquid hydrocarbon. The type, density, and penetration of needles used are varied at this level.

A barrier fabric is prepared by assembling and needle-punching two layers of polypropylene non-woven fabrics (e.g. Albarrie 600R or 300R) sandwiching a layer of the test substance.

The barrier fabric is prepared using a laboratory size needling system (12 in.). A strip of a non-woven fabric, typically 300 to 360 mm wide and 2000 mm long, is covered with a uniform layer of the test substance in powder form. The area coverage is equivalent to about 2.5 kg/m². The layer of the test substance is covered with another layer of nonwoven fabric and the entire assembly is processed using the needle-punching machine.

Samples of the barrier fabric, each having a diameter of 118 mm, are die cut. The samples are then placed in the large rig. The large rig is similar to, but larger than, the small rig, and the large rig accommodates the samples having a diameter of 118 mm, as opposed to the small rig, which accommodates samples having a diameter of 57 mm.

The large rig is closed and filled with a transformer oil. The transformer oil may be, for instance, Hyvolt™ II (from Ergon™ Refining), Luminol™ TRI (from PetroCanada™), or others. A dye is added to the transformer oil, wherein the dye is less than 0.01% by weight of Oil Blue N dye dissolved in the oil 24 hours prior to testing. The column of the hydrocarbon in the rig test is 150 mm (equivalent roughly to 6″). The large rig is left undisturbed for 72 hrs (or longer; in some cases, up to one month).

After 72 hrs (or longer), the liquid hydrocarbon is pumped out of the rig, and the sample is isolated and evaluated. The sample is cut to reveal its cross-section.

If any liquid hydrocarbon visibly leaks from the large rig through the sample fabric, the test substance does not proceed to the next test. If the bottom fabric disk of the sample fabric has been exposed to any liquid hydrocarbon, the test substance does not proceed to the next test.

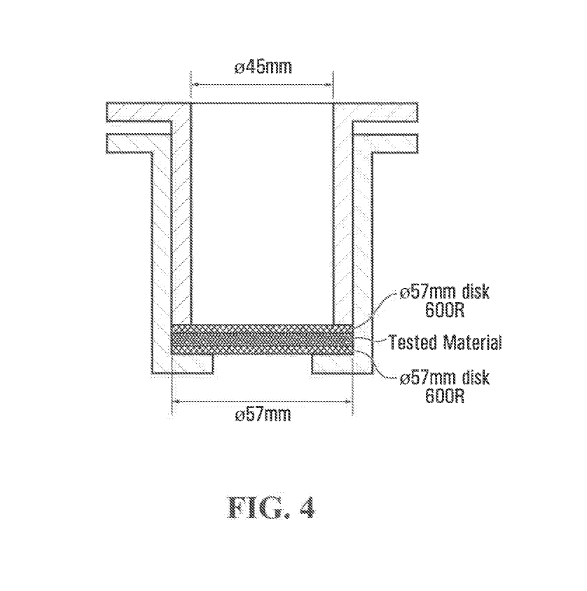

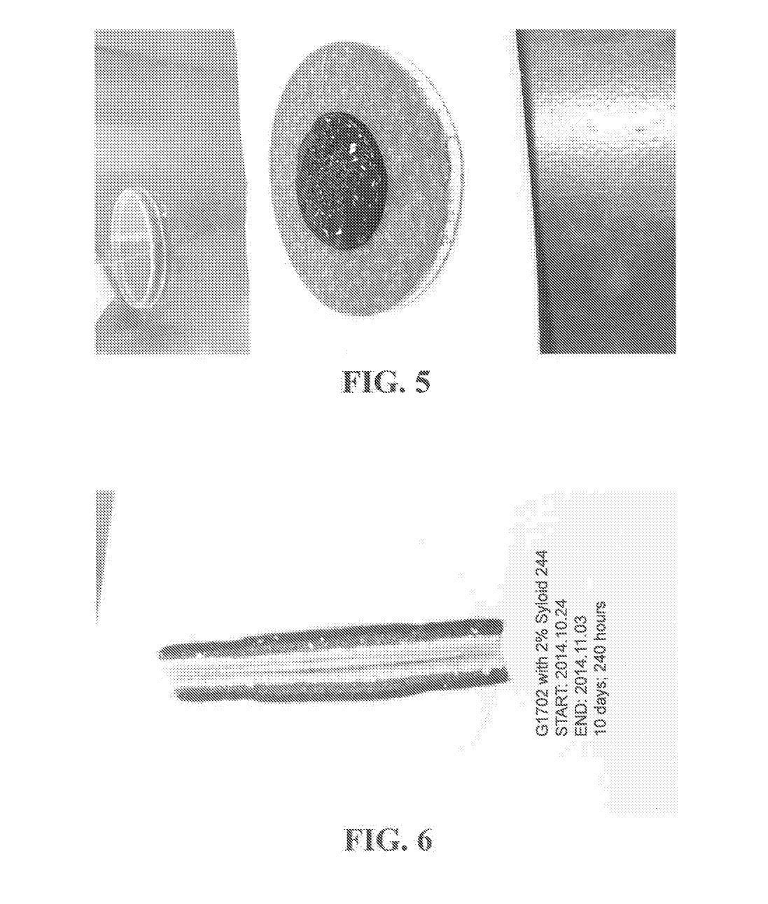

FIG. 5 shows a 31.45 g sample comprising Kraton G1702 and 2% by weight silica (Syloid™ 244) exposed to Hyvolt oil (with dark blue dye) for approximately 10 days. FIG. 6 shows a cross-section of the sample, folded in half (clean sides together) after 10 days (240 hrs). The layer of the reacted polymer (dark, due to the dye in the oil) exposed to the liquid hydrocarbon and the un-reacted layer (light), are visible. The sample with a layer comprising Kraton G1702 and 2% by weight silica passed the Level 3 test. It is also noted that prior to contact with the liquid hydrocarbon, the sample allowed water to flow at about 1 L per 6 minutes.

Similar results were obtained with a 38.06 g sample of 118 mm. It allowed 400 mL of water to drain in less than 10 minutes. When contacted with Hyvolt oil, there were no visible leaks to the bottom side of the sample after approximately 6 days. The oil penetrated about ⅓ of the way down the polymer layer.

Level 3: Large Rig Test (with Heated Liquid Hydrocarbon)

The Level 3 test was repeated, but with the rig preheated to a temperature of 62° C. for 5 hours and the transformer oil, Hyvolt II™, preheated to 67° C. The heated transformer oil was poured into the heated rig and left to naturally cool down to room temperature. No visible leaks to the bottom side of the sample were observed after 24 hours.

### Level 4 Test

This is a simulation of a fully assembled containment site. A model containment system, including all system components, is assembled inside a box which simulates a containment basin.

The box is itself has dimensions of about 48.5 cm×48.5 cm and a height of 30 cm. The exact dimensions are not critical. The walls of the box are made from impermeable material (metal, plastic, plywood, etc). The bottom of the box is left open and covered with an open steel mesh or grid. A sheet of Steel Expanded Metal—Flattened (¼ in. Diamond x 18 GA) was used. The bottom mesh allows water to freely flow.

The box is assembled from the bottom as follows: (1) a layer of geotextile fabric 600R (Albarrie™) of 46 cm×46 cm is placed directly on the metal mesh; (2) a 2.5 cm layer of coarse wet sand is placed on the geotextile fabric; (3) a sheet of impermeable liner (HDPE liner, PU line, or any other compatible liner) is placed inside and folded to form a seamless liner covering the bottom and the walls of the box; (4) an opening 20 cm×20 cm is cut in the bottom center of the liner: (5) a sample of fabric 46 cm×46 cm with viscosity modifier (Kraton G1702 with 2% Syloid) is bonded to the liner along the edges using hydrocarbon resistant sealant with the bond being between the top surface of the liner and the bottom surface of the fabric; (6) a further sheet of impermeable liner with an opening of 20 cm×20 cm is placed on top of the sample fabric and bonded to it, with the bond being between the top of the fabric and the bottom of the liner; (7) a sample of fabric 46 cm×46 cm with an absorbent polymer is placed on top of the liner, in an unbonded and unsealed manner; (8) a 2.5 cm layer of wet coarse sand is placed on top of the absorbent fabric: (9) a layer of geotextile fabric 600R 46 cm×46 cm is placed on top of the sand; and (10) a 15 cm layer of crushed stone or other porous mineral rock (the “stone layer”) is placed on top of the geotextile fabric. The assembled box is left for 24 hours to settle.

The box is filled with water to fully cover the top stone layer from step (10) above. The water is drained from the box, to show that the layer of viscosity modifier is water-permeable. The box is then filled with test oil to fully cover the top stone layer. The box is left for 72 hours or longer. After this time, the oil is pumped out and the system is disassembled and the fabrics inspected for oil penetration.

Samples of sand are collected and tested for oil contamination. The test is considered a success if there are no traces of oil in the very bottom sand layer.

It is noted that the oil can be dyed with, for instance, Oil Blue N dye, and a layer of white polyester needle-punched fabric can be placed directly on top of the bottom sand layer (and below the opening in the bottom impermeable liner) to act as a color indicator to observe whether oil leaked through the fabric with viscosity modifier.

There appeared to be no traces of oil in the very bottom sand layer when fabric with viscosity modifier was tested in the model containment system.

### Level 5 Test

The Level 5 test is similar to the Level 4 test, but on a larger scale. A box similar to the Level 4 test is used. The box in this test may be about 118 cm×110.5 cm with a height of around 61 cm. The exact dimensions are not critical.

The box is assembled from the bottom as follows: (1) a layer of geotextile fabric 600R (Albarrie™) of 117 cm×109 cm is placed directly on the metal mesh; (2) a 2.5 cm layer of coarse wet sand is placed on the geotextile fabric: (3) a sheet of impermeable liner (HDPE liner, PU line, or any other compatible liner) is placed inside and folded to form a seamless liner covering the bottom and the walls of the box; (4) an opening 48 cm×56 cm is cut in the bottom center of the liner; (5) a sample of fabric 117 cm×109 cm with viscosity modifier (Kraton G1702 with 2% Syloid) is bonded to the liner along the edges using hydrocarbon resistant sealant with the bond being between the top surface of the liner and the bottom surface of the fabric; (6) a further sheet of impermeable liner with an opening of 48 cm×56 cm is placed on top of the sample fabric and bonded to it, with the bond being between the top of the fabric and the bottom of the liner; (7) a sample of fabric 117 cm×109 cm with an absorbent polymer is placed on top of the liner, in an unbonded and unsealed manner; (8) a 2.5 cm layer of wet coarse sand is placed on top of the absorbent fabric; (9) a layer of geotextile fabric 600R 117 cm×109 cm is placed on top of the sand; and (10) a 15 cm layer of crushed stone or other porous mineral rock (the “stone layer”) is placed on top of the geotextile fabric. The assembled box is left for 24 hours to settle.

The box is filled with water to fully cover the top stone layer from step (10) above. The water is drained from the box, to show that the layer of viscosity modifier is water-permeable. The box is then filled with test oil to fully cover the top stone layer. The box is left for 72 hours or longer. After this time, the oil is pumped out and the system is disassembled and the fabrics inspected for oil penetration.

Samples of sand are collected and tested for oil contamination. The test is considered a success if there are no traces of oil in the very bottom sand layer.

It is noted that the oil can be dyed with, for instance, Oil Blue N dye, and a layer of white polyester needle-punched fabric can be placed directly on top of the bottom sand layer (and below the opening in the bottom impermeable liner) to act as a color indicator to observe whether oil leaked through the fabric with viscosity modifier.

There appeared to be no traces of oil in the very bottom sand layer when fabric with viscosity modifier was tested in the model containment system.

### Longer-Term Testing

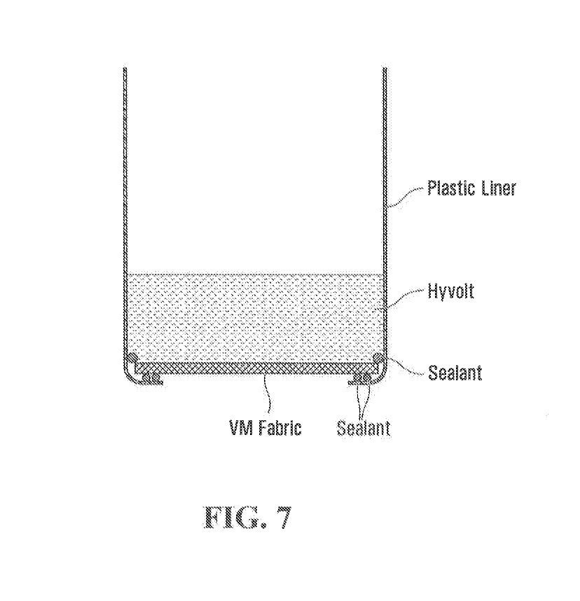

A textile barrier with a layer of viscosity modifier was tested to determine whether it could prevent transformer oil from leaking through over several months. A bucket having an open bottom, made of polyurethane plastic liner, was used for this purpose. The bucket had a diameter of about 26 cm and is about 35 cm in height. The liner was bonded to the textile barrier with beads of moisture curable sealant. A drawing of the bucket is depicted in FIG. 7. The sealant was left to cure for 48 hours. The bucket was filled with water and drained.

Hyvolt II™ transformer oil was then added to the bucket, until it reached a height of about 50 mm. The apparatus and oil were left for 3.5 months. There was no visible leakage of the oil from the bottom of the bucket, and the bottom side of the textile barrier had no visible traces of the oil.

Although the foregoing invention has been described in detail for purposes of clarity of understanding, it is readily apparent those of ordinary skill in the art in light of the teachings of this invention that certain changes and modifications may be made thereto without departing from the scope of the appended claims.

1. A barrier for containing or reducing a leak of a liquid hydrocarbon comprising a viscosity modifier, wherein upon contact with the liquid hydrocarbon the viscosity modifier disperses into and increases the viscosity of the liquid hydrocarbon.

2. The barrier of claim 1, wherein the viscosity modifier dissolves into and increases the viscosity of the liquid hydrocarbon.

3. The barrier of claim 1 or 2, wherein the viscosity modifier is a powder or a granulate.

4. The barrier of claim 1, 2 or 3, wherein the viscosity modifier is water-insoluble.

5. The barrier of any one of claims 1 to 4, wherein the viscosity modifier is highly soluble in the liquid hydrocarbon.

6. The barrier of any one of claims 1 to 5, wherein the viscosity modifier is a polymer.

7. The barrier of claim 6, wherein the polymer comprises ethylene and/or propylene monomers.

8. The barrier of claim 7, wherein the polymer is a diblock copolymer.

9. The barrier of claim 8, wherein the diblock copolymer is a poly(styrene-ethylene/propylene) (SEP) copolymer.

10. The barrier of claim 9, wherein the SEP copolymer has a styrene content of 36% by weight or less.

11. The barrier of any one of claim 9 or 10, wherein the viscosity modifier has a particle surface more developed than Septon 1020.

12. The barrier of any one of claims 1 to 11, wherein the viscosity modifier is Kraton G1702.

13. The barrier of any one of claims 6 to 12, wherein the polymer is comprised in a polymer blend, wherein the polymer blend is the viscosity modifier.

14. The barrier of claim 13, wherein the polymer blend comprises Kraton G1702 with one or more of Kraton G1652, Kraton G1650, Europrene SOL TH 2312, and Europrene SOL TH 2315.

15. The barrier of any one of claims 1 to 11, wherein the viscosity modifier is Kraton MD6953 or Kraton G1750.

16. The barrier of any one of claims 1 to 15, wherein an additive is comprised in the viscosity modifier.

17. The barrier of claim 16, wherein the additive is a glidant.

18. The barrier of claim 17, wherein the glidant is silica.

19. The barrier of claim 18, wherein the glidant is about 1 to 5% by weight of the silica.

20. The barrier of claim 19, wherein the glidant is about 2% by weight of the silica.

21. The barrier of claim 18, 19, or 20, wherein the silica is Syloid™ 244.

22. The barrier of claim 18, 19, or 20, wherein the silica is Aerosil™ R972.

23. The barrier of claim 16, wherein the additive is a lubricant, partitioning agent, or excipient.

24. The barrier of any one of claims 1 to 23, wherein a particle size of the viscosity modifier is 300 μm to 1 mm.

25. The barrier of any one of claims 1 to 24, comprising a minimum of 1.2 kg/m² of the viscosity modifier.

26. The barrier of any one of claims 1 to 25, wherein the viscosity modifier is comprised in a layer, and a minimum thickness of the layer is 1 mm.

27. The barrier of claim 1, wherein the viscosity modifier is a tackifier.

28. The barrier of claim 26, wherein the viscosity modifier is a wood resin.

29. The barrier of claim 27, wherein the wood resin is a rosin resin.

30. The barrier of claim 1, wherein the viscosity modifier is aluminum stearate, a hydrogenated vegetable oil, or an ethylene propylene diene monomer (EPDM) terpolymer.

31. The barrier of any one of claims 1 to 30, wherein the barrier further comprises a textile fabric.

32. The barrier of claim 31, wherein the barrier comprises a bottom and a top layer of the textile fabric sandwiching a layer of the viscosity modifier, and the layers are needle-punched together.

33. The barrier of any one of claims 1 to 32, wherein the viscosity modifier dissolves or mixes into the liquid hydrocarbon in less than one minute.

34. The barrier of any one of claims 1 to 32, wherein the viscosity modifier dissolves or mixes into the liquid hydrocarbon in less than about 15 seconds.

35. A set of barriers for containing or reducing a leak of liquid hydrocarbon, comprising the barrier of any one of claims 1 to 34, and comprising a further barrier positioned to contact the liquid hydrocarbon before the barrier comprising the viscosity modifier.

36. The set of barriers of claim 35, wherein the further barrier comprises an absorbent or polymer gel.

37. The set of barriers of claim 36, wherein the absorbent or polymer gel is a powder or granulate.

38. The set of barriers of claim 36 or 37, wherein the absorbent or polymer gel is at least one of hydrogenated poly(styrene-ethylene/propylene) (SEP) copolymers, hydrogenated poly(styrene-isoprene-styrene) (SEPS) copolymers, hydrogenated poly(styrene-butadiene-styrene) (SEBS) copolymers, hydrogenated poly(styrene-isoprene/butadiene-styrene) (SEEPS) copolymers; EPDM rubbers in powdered or granular form; aluminum soaps of naphtenic and palmitic acids (such as aluminum octoate) in powdered or granular form; and modified polyamide hydrocarbon gellants and resin blends.

39. The set of barriers of claim 38, wherein the gellants and resin blends are at least one of ester-terminated polyamides, tertiary amide terminated polyamides, ester-terminated poly(ester-amides), polyalkyleneoxy-terminated polyamides and polyether polyamides.

40. The set of barriers of claim 36 or 37, wherein the absorbent or polymer gel is at least one layer of a hydrogenated poly(styrene-b-isoprene) (SEP) copolymer, a hydrogenated poly(styrene-b-isoprene-b-styrene) (SEPS) copolymer, a hydrogenated poly(styrene-b-butadiene-b-styrene) (SEBS) copolymer, and a hydrogenated poly(styrene-b-isoprene/butadiene-b-styrene) (SEEPS) copolymer.

41. The set of barriers of any one of claims 35 to 40, wherein the surface density of the absorbent or polymer gel is in the range from 10 g/m² to 5,000 g/m².

42. The set of barriers of any one of claims 35 to 41, wherein the further barrier comprises a bottom and a top layer of textile sandwiching a layer of the absorbent or polymer gel, and the layers are needle-punched together.

43. An oil spill containment system for containing oil spills or leaks from an oil containing vessel, comprising: a containment basin, a barrier of viscosity modifier contained within the basin; a barrier of oil-absorbing material also contained within the basin, on top of the barrier of viscosity modifier, and wherein the layer of viscosity modifier when contacted with oil, forms a viscous fluid which prevents oil and water from passing through.

44. The oil spill containment system of claim 43, wherein the barrier of viscosity modifier is defined in any one of claims 1 to 34.

45. The oil spill containment system of claim 43 or 44, wherein the barrier of oil-absorbing material is the further barrier as defined in any one of claims 35 to 42.

46. An oil spill containment system for containing oil spills or leaks from an oil containing vessel, comprising: a containment basin, a barrier of viscosity modifier contained within the basin, wherein the viscosity modifier is Kraton G1702 and about 2% silica; a barrier of oil-absorbing material also contained within the basin, on top of the barrier of viscosity modifier, and wherein the layer of viscosity modifier when contacted with oil, forms a viscous fluid which prevents oil and water from passing through.
